(19) United States
(12) Patent Application Publication
(10) Pub. No.: US 2005/0160867 A1
(43) Pub. Date: Jul. 28, 2005

(54) Idle stop apparatus

(76) Inventor: Erik Mannle, Oberkich (DE)

Correspondence Address: Mary R Bonzagni;Holland & Bonzagni, 171 Dwight Road, Suite 302, Longmeadow, MA, 01106-1700, US

(21) Appl. No.: 10/494,849

(22) PCT Filed: Nov. 6, 2002
(86) PCT No.: PCT/IB02/05387

(30) Foreign Application Priority Data
Nov. 6, 2001 (GB) 0126607.1

(51) Int. Cl. G05G 1/14

(52) U.S. Cl. 74/512; 74/560

(57) ABSTRACT

An idle stop mechanism for a foot pedal (12) that comprises a column (32) that resists the motion of a foot pedal arm, the column being held so as to resist rotational and axial movement.

This invention relates to the field of idle stop apparatus for foot pedals and in particular to such apparatus that have application in ‘drive-by-wire’ applications for motor vehicles.

‘Drive-by-wire’ control systems for motor vehicles replace the mechanical linkages between a control, for example a steering wheel or a foot pedal, and the vehicle system with which they are associated, for example the steering rack or the throttle. Instead, an electrical signal is generated within the control and transmitted to an engine management system which will then send one or more control signals out to various vehicle subsystems, for example, to activate the brakes or to vary the amount of fuel being injected into the engine.

One of the requirements of ‘drive-by-wire’ systems is to have an accurate determination of the idle point of the accelerator pedal, that is the point at which no force is applied to the accelerator pedal by the driver and thus the engine should only be operating at the idle speed, which will be determined by the engine management system in response to the temperature of the engine, the electrical load which the engine must meet, etc. An accurate determination of idle point is important for the economic functioning of the engine and in order to reduce harmful emissions from the engine. Additionally, it is vital that small changes in the control signal generated from the accelerator pedal can be ascribed to a small movement of the pedal rather than hysteresis in the pedal mechanism, to give the driver control of the vehicle when operating at low powers, for example when parking and manoeuvring. It will be understood clearly that the present apparatus could also find application in conventional vehicles that do not use ‘drive-by-wire’ systems.

According to a first aspect of the invention there is provided a pedal mechanism comprising a pedal mounted on a first end of a pivoted pedal arm, the second free end of the pedal arm being received within a housing, resistive means urging the pedal arm in one rotational direction and opposition means that engage with the second end of the pedal arm and oppose the urging of the resistive means, the opposition means comprising one or more axial engagement means that engage with the housing to resist axial movement of the opposition means and one or more rotational engagement means that engage with the housing to resist rotational movement of the opposition means. Preferably, the opposition means comprises a projecting member that is parallel and eccentric with regard to the axis of the opposition means, the projecting member being received within the housing.

The rotational engagement means may comprise one or more teeth that engage with corresponding teeth formed in the housing. This provides the advantage that once the opposition means has been inserted into the pedal mechanism, the teeth intermesh and resist the rotation of the opposition means. The rotational engagement means may comprise an elongate member inserted through an aperture within the opposition means. The axial engagement means may comprise one or more resilient members that grip the internal surface of the housing to resist the extraction of the opposition means once it has been inserted into the pedal mechanism.

According to a second aspect of the present invention there is provided an apparatus for opposing the motion of a foot pedal comprising a column, one or more axial engagement means and one or more rotational engagement means, the column, in use, opposing the rotational motion of a foot pedal. Preferably, the column comprises a projecting member that is parallel and eccentric with regard to the axis of the column, the projecting member being configured to engage, in use, with an aperture.

The rotational engagement means may comprise one or more teeth configured to engage, in use, with corresponding teeth and/or the rotational engagement means may comprise an elongate member configured to engage with an aperture within the apparatus. These arrangements provide resistance to the rotation of the opposition means once it has been inserted within a suitable housing. The axial engagement means may comprise one or more resilient members configured to engage, in use, a surface to resist the extraction of the opposition means once it has been inserted within a suitable housing.

The invention will now be described, by way of example only, with reference to the following Figure in which:

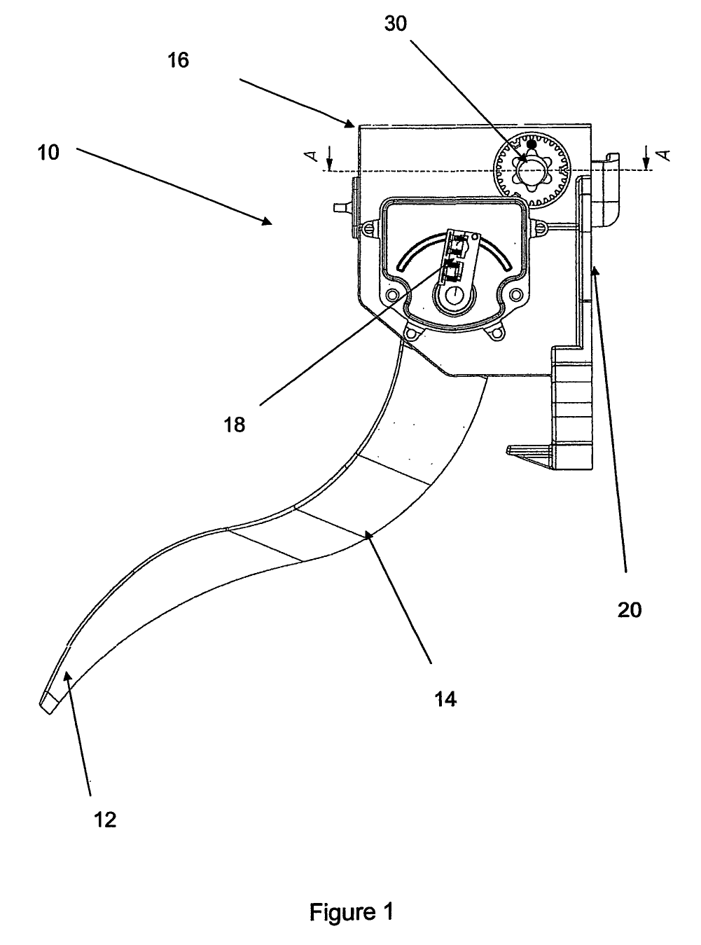

FIG. 1 shows a schematic depiction of a side view of a pedal mechanism incorporating an idle stop unit according to the present invention;

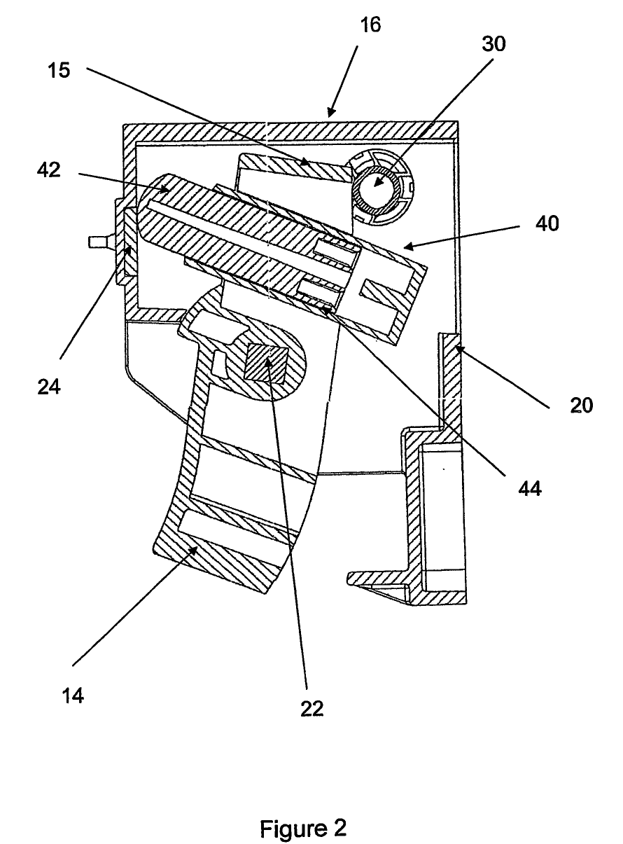

FIG. 2 shows a schematic depiction of a sectional view of a pedal mechanism incorporating an idle stop unit according to the present invention; and

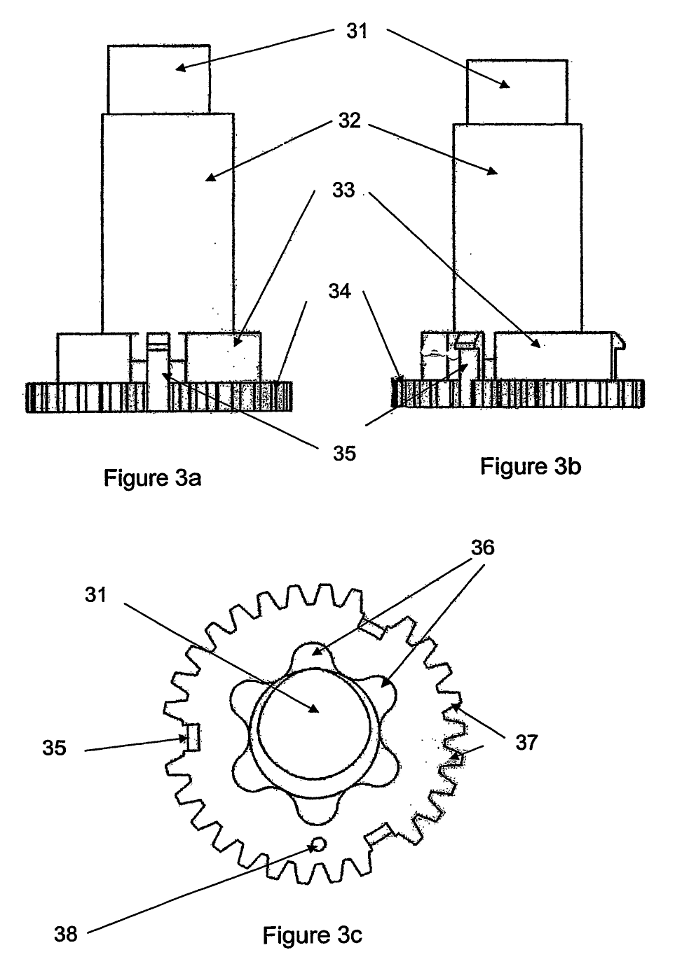

FIG. 3 shows a schematic depiction of an idle stop unit according to the present invention.

FIGS. 1 and 2 show a side view and a sectional view, respectively, of a pedal mechanism incorporating the present invention. Pedal mechanism 10 comprises pedal 12, pedal arm 14, housing 16, sensor unit 18, idle stop unit 30 and friction unit 40. Pedal 12 is mounted on a free end of pedal arm 14 and when pressure is applied to the pedal from the driver's foot the pedal arm 14 rotates about a pivot 22. The pedal arm is coupled to a sensor unit 18 that produces an output that varies with the degree of rotation of the pedal arm; this output is preferably an electrical voltage that can be transmitted to the engine control unit which will regulate the behaviour of the vehicle systems in response to the rotation of the pedal arm and hence the position of the pedal. The pivot and the pedal arm are received inside a housing 16 that comprises a base 20 for fastening to the interior of a vehicle.

Friction unit 40 provides a ‘feel’ to the pedal mechanism that is similar to the ‘feel’ of a traditional accelerator pedal. Friction element 40 comprises piston 42 which is received inside cylinder 44. The friction element additionally comprises a resistive element that urges a rounded end of piston 42 into contact with the interior wall of the housing 16 that is opposite to the base 20. As the pedal is depressed and the pedal arm rotates, the rounded end of the piston moves across friction pad 24, which is embedded within the housing 16. Friction element additionally comprises a resistive element (not shown) that opposes the rotation of the pedal arm as the pedal is depressed. When no pressure is applied to the pedal the resistive element urges the pedal arm back to its rest position.

Idle stop unit 30 is shown in greater detail in FIG. 3. FIG. 3a shows one side view of the idle stop unit, FIG. 3b shows a side view that is perpendicular to the view shown in FIG. 3a and FIG. 3c shows a plan view of the idle stop unit. The idle stop unit 30 comprises eccentric stop 311, column 32, surround 33 a plurality of engagement means 35, gear wheel 34 which comprises a plurality of teeth 37 and aperture 38. Eccentric stop 31 is received in a hole in the side of the casing 16 such that the free end 15 of the pedal arm 15 that is contained within the housing rests upon column 32. As the free end 15 is urged towards the column by the resistive element of the friction element 40 it is important that the column is located within the limits of travel of the pedal arm.

Gear wheel 34 is provided to mesh with a corresponding set of teeth that is arranged around a second hole that is located on the face of the housing opposed to the first hole that receives the eccentric stop 31. The idle stop unit is partially inserted through the second, toothed hole until the stop 31 is received within the first hole. Once the column is in the correct position with respect to free end 15 of the pedal arm the idle stop unit can be fully inserted into the housing. The end of column section 32 butts up against the inside of the housing 16 as it is unable to pass through the first hole and the resilient engagement means 35 will snap onto the interior of the opposite face of the housing to act against the removal of the idle stop unit. The teeth 37 will mesh with the corresponding teeth formed in the housing to resist any rotation of the idle stop unit. Additional resistance to rotation can be provided by placing a locking pin through aperture 38, which is located eccentrically on the idle stop unit.

1. A pedal mechanism comprising a pedal mounted on a first end of a pivoted pedal arm, the second free end of the pedal arm being received within a housing, resistive means urging the pedal arm in one rotational direction and opposition means that engage with the second end of the pedal arm and oppose the urging of the resistive means, the opposition means comprising one or more axial engagement means that engage with the housing to resist axial movement of the opposition means and one or more rotational engagement means that engage with the housing to resist rotational movement of the opposition means.

2. A pedal mechanism according to claim 1 in which the opposition means comprises a projecting member that is parallel and eccentric with regard to the axis of the opposition means, the projecting member being received within the housing.

3. A pedal mechanism according to claim 1, in which the rotational engagement means comprise one or more teeth that engage with corresponding teeth formed in the housing.

4. A pedal mechanism according to claim 1, in which the rotational engagement means comprise an elongate member inserted through an aperture within the opposition means.

5. A pedal mechanism according to claim 1, in which the axial engagement means comprise one or more resilient members that grip the internal surface of the housing.

6. An apparatus for opposing the motion of a foot pedal comprising a column, one or more axial engagement means and one or more rotational engagement means, the column, in use, opposing the rotational motion of a foot pedal.

7. An apparatus according to claim 6 in which the column comprises a projecting member that is parallel and eccentric with regard to the axis of the column, the projecting member being configured to engage, in use, with an aperture.

8. An apparatus according to claim 6, in which the rotational engagement means comprise one or more teeth configured to engage, in use, with corresponding teeth.

9. An apparatus according to claim 6, in which the rotational engagement means comprise an elongate member configured to engage with an aperture within the apparatus.

10. An apparatus according to claim 6, in which the axial engagement means comprise one or more resilient members configured to engage, in use, a surface.

11. A pedal mechanism according to claim 2, in which the rotational engagement means comprise one or more teeth that engage with corresponding teeth formed in the housing.

12. An apparatus according to claim 7, in which the rotational engagement means comprise one or more teeth configured to engage, in use with corresponding teeth.

13. An apparatus according to claim 7, in which the rotational engagement means comprise an elongate member configured to engage with an aperture within the apparatus.

14. An apparatus according to claim 8, in which the rotational engagement means comprise an elongate member configured to engage with an aperture within the apparatus.

15. An apparatus according to claim 12, in which the rotational engagement means comprise an elongate member configured to engage with an aperture within the apparatus.

16. An apparatus according to claim 7, in which the axial engagement means comprise one or more resilient members configured to engage, in use, a surface.

17. An apparatus according to claim 8, in which the axial engagement means comprise one or more resilient members configured to engage, in use, a surface.

18. An apparatus according to claim 12, in which the axial engagement means comprise one or more resilient members configured to engage, in use, a surface.

19. An apparatus according to claim 9, in which the axial engagement means comprise one or more resilient members configured to engage, in use, a surface.

20. An apparatus according to claim 13, in which the axial engagement means comprise one or more resilient members configured to engage, in use, a surface.

21. An apparatus according to claim 14, in which the axial engagement means comprise one or more resilient members configured to engage, in use, a surface.

22. An apparatus according to claim 15, in which the axial engagement means comprise one or more resilient members configured to engage, in use, a surface.
